(19) United States
(12) Patent Application Publication
(10) Pub. No.: US 2009/0058083 A1
(43) Pub. Date: Mar. 5, 2009

(54) Staple for a hose coupling

(75) Inventors: Scott Robert Dorman, Greensborough (AU); Leigh Wayne Morrison, Footscray (AU)

Correspondence Address: OLIFF & BERRIDGE, PLC, P.O. BOX 320850, ALEXANDRIA, VA, 22320-4850, US

(73) Assignee: RYCO HYDRAULICS PTY LTD, Footscray (AU)

(21) Appl. No.: 12/230,153

(22) Filed: Aug. 25, 2008

(30) Foreign Application Priority Data
Sep. 3, 2007 (AU) 2007904763

(51) Int. Cl. F16L 37/00

(52) U.S. Cl. 285/309; 285/305

(57) ABSTRACT

A staple for interlocking an engageable male part and a female part of a hose coupling. The staple has two tines which are insertable into two bores on the female part to seat within a groove on the male part when the male part and female part are engaged. The tines of the staple have an irregular cross sectional shape such that when the male and female parts and are biased apart, the female part bears against an outer region of the tines such that there is a resultant force which biases the tines into the groove, thereby making it more difficult for the staple to be unintentionally removed whilst the hose coupling is under pressure.

### TECHNICAL FIELD

The present invention relates to a staple for interlocking an engageable male part and a female part of a hose coupling, and the hose coupling.

### BACKGROUND

Hose couplings including an engageable male part and a female part which are interlockable by a staple are used in the mining industry to connect hydraulic hose assemblies. The staple which interlocks the male part and the female part has two tines which are insertable into two bores on the female part to seat within an annular groove on the male part when the male part and female part are engaged. Hoses or other components such as adapters may be connected to the male and female parts of the coupling.

In the mining industry, hydraulic hose couplings can be subject to pressures of up to 420-500 bars when fluid is static or flowing in the hose. The pressure in the hose coupling may spike or fluctuate over time. External mechanical tension or stress to the hose may also subject the hose coupling to pressure. The male and female parts of the hose coupling bias apart when the hose coupling is under pressure, resulting in a force on the tines of the staple due to the male and female parts bearing against the tines.

Known shapes of staple tine cross sections include square/rectangular, circular and D shapes. These shapes have a disadvantage that when the male and female parts are biased apart, the force developed on the tines by the male and female parts bearing on the tines is concentrated at particular positions of the cross section of the tines, causing wear and localised stress at those positions and the corresponding positions on the male and female parts that bear against the tines at those positions. This may cause undesirable bending of the staple.

### DISCLOSURE OF THE INVENTION

The present invention aims to provide a staple with tines having a cross section that provides advantages over the square/rectangular, circular and D shape cross sections.

Viewed from one aspect, the present invention provides:
a staple for interlocking an engageable male part and a female part of a hose coupling,
the male part having a longitudinal axis and an external annular groove and the female part having two bores positioned to align with the groove on the male part when the male part is engaged with the female part,
the staple having two tines which are insertable into the two bores on the female part to seat within the groove on the male part when the male part and female part are engaged,
wherein the tines each have an irregular cross sectional shape such that when the male and female parts are biased apart, the female part bears against an outer region of the tines such that there is a resultant force which biases the tines into the groove.

Thus, the resultant force that is developed on the tines by the female part when the coupling is under pressure, due to the irregular cross sectional shape of the tines that provides the outer bearing region, causes the tines to be forced together to grip the male part. This tightens the interlock between the male and female parts of the hose coupling provided by the staple, making it more difficult for the staple to be unintentionally removed whilst the hose coupling is under pressure. The biasing of the tines into, rather than out of the groove also means that the tines do not bend outwardly of the groove when the hose coupling is under pressure. Known staple cross sections change shape over time due to this outwards bending.

The staple is generally U shaped and the definition “outer region” of the tines means a region that is positioned outwardly of the U and in use of the staple sits outwardly of the groove on the male part. The definition “inner region” of the tines means a region on each tine that is positioned inwardly of the U and in use of the staple sits within the groove.

Where the groove on the male part has a base surface, an embodiment of the invention includes the tines having a cross section such that when the male and female parts are biased apart, the female part bears against the tines such that the tines contact and exert a force on the base surface of the groove.

Whether the tines contact and exert a force on the base surface of the groove will depend on the depth of the groove and the cross sectional size of the tines relative to the width of the groove. Contact between the tines and the base of the groove provides a tighter interlock between the male and female parts of the hose coupling.

The cross section of the tines may have a clearance portion on an inner region of the tines such that when the male and female parts are biased apart there is a clearance between the female part and the inner region of the tines. The clearance portion may be curved and substantially match the curve of the bores in the female part, so as to allow maximisation of the cross section of the tines and therefore the strength of the staple.

The outer region of the tines that the female part bears against when the male and female parts are biased apart may be curved. This curved outer portion may substantially match the curve of the bores on the female part. The force developed on the tines by the female part bearing on the tines when the hose coupling is under pressure is then spread across a region of the cross section of the tines and is not concentrated at a particular position, thus reducing stress concentration on the tines and increasing the useful life of the staple. Having a curved portion substantially matching the curve of the female bore also allows maximisation of the cross section of the tines and therefore the strength of the staple.

The cross section of the tines of a staple in accordance with an embodiment of the invention may be non-symmetrical. The known square/rectangular, circular and D shape cross sections are all symmetrical about an axis lying transverse to the longitudinal axis of the male part. In using a staple having tines with a symmetrical cross section, the staple can be inserted either way around. Over time, however, the tines of a staple inserted in a hose coupling change shape due to the pressure and pressure fluctuations experienced. If the staple is then removed from the coupling and reinserted in a different orientation, it is more likely that the staple will fail when subject to pressure. Staples are therefore usually reinserted in the same orientation and so, once they have been inserted a first time, there is no disadvantage in using a non-symmetrical cross section staple. A staple having tines of a non-symmetrical cross section may have a greater cross section than those of a symmetrical cross section staple as they may be designed to more closely fit the size and shape of the groove on the male part and bores on the female part of the hose coupling.

The cross section of the tines may have adjacent flat sides normal to each other that bear against a side and base surface of the groove on the male part when the male and female parts are biased apart. The tines may then bear against a greater area of the groove, meaning that the force exerted on the groove is not concentrated at particular positions on the groove. Having flat sides substantially matching the flat sides of the groove also allows maximisation of the cross section of the tines and therefore the strength of the staple.

The cross section of the tines may have a shaped portion on an inner region of the tines, opposite to the outer region of the tines that the female part bears against, that facilitates the seating of the tines within the groove. This shaped portion allows the staple to be inserted and removed from the hose coupling more easily.

The cross section of the tines may have adjacent flat sides normal to each other, a shaped portion between the adjacent flat sides, a curved side on an outer region of the tines including a curved portion that the female part bears against when the male and female parts are biased apart, a clearance portion on an inner region of the tines that provides a clearance between the female part and the inner region of the tines when the male and female parts are biased apart and a flat side connecting the curved portion and clearance portion. This embodiment allows maximisation of the cross section of the tines whilst providing the advantages outlined previously.

It will be appreciated, that while embodiments described above outline advantages of curved tines substantially matching the curve of the female bores, if the female bores are machined to have a non-curved cross section, the shape of the tines may substantially match this non-curved cross section of the bores so as to provide equivalent advantages. In this specification, the word “bore” is to be understood as including a hole or passage in the female part that may have other than a circular cross section.

In any of the above mentioned embodiments, at least one of the tines may have a recess that seats within the groove on the male part when the male and female parts are engaged and the staple is fully inserted. The recess allows the tines to grip around the groove on the male part, further impeding the unintentional removal of the staple whilst the hose coupling is under pressure and preventing the staple from falling out under nil pressure.

The length of the recess may be substantially the diameter of the groove. This provides the advantage that the tines of the staple are not bent as the hose coupling is subjected to pressure, meaning that the staple does not change shape over time and the staple may be less likely to fail. The tines of known staples, when inserted in a hose coupling, change shape over time due to pressure and pressure fluctuations experienced.

The tines may be parallel to each other, inclined together or partly parallel and partly inclined together. Having parallel tines provides the advantage that the tines are not biased away from the groove (as occurs in many known staples which have flared tines) and are therefore not as likely to be unintentionally removed from the hose coupling when it is under pressure.

Another advantage of a staple with parallel tines is that the staple may be more easily inserted into the hose coupling as the tines do not need to be squeezed together during insertion.

Inclined together or partly inclined together tines may assist in holding the tines within the hose coupling when it is not under pressure. When the hose coupling is under pressure, such tines may make it more difficult for the staple to be unintentionally removed from the hose coupling.

The staple may have a bent portion connecting the two tines, the bent portion lying on an angle to the tines, for example an angle of substantially 90 degrees to the tines. Where the cross section of the tines is non-symmetrical and where a staple has been removed and is to be reinserted, it is important that it is inserted in the correct orientation. Staples are often inserted into hose couplings in harsh environments, such as in underground mines, where factors such as poor lighting and coal dust may make it difficult to see the cross section of the tines clearly. The staple may also be handled through gloves, making it difficult to feel the shape of the cross section. The bent portion provides a visual and tactile indication of the orientation in which the staple should be inserted.

Also the bent portion provides an area of the staple which may be labelled, for example by attaching a separate label or engraving information on the staple. It is a particularly advantageous position to place a label as it is an easily visible, low stress area of the staple that does not affect the functionality of the staple. Such labelling may be applied in order to differentiate between different sizes and types of staple, to indicate the date of manufacture, maximum working pressure or to provide other information. In some states, Government regulations or guidelines may require staples to be labelled.

The staple tines may have chamfered ends, for ease of insertion and removal of the staple from the hose coupling. The side of the tine facing the female part, the side of the tine facing the male part or both sides of the tine could be chamfered. The length of the tines may be varied to suit different sized female parts of the hose coupling.

Viewed from another aspect, the present invention provides a staple for interlocking an engageable male part and a female part of a hose coupling, the male part having a longitudinal axis and an external annular groove and the female part having two bores positioned to align with the groove on the male part when the male part is engaged with the female part, the staple having two tines which are insertable into the two bores on the female part to seat within the groove on the male part when the male part and female part are engaged, wherein the tines each have an irregular cross sectional shape such that when the male and female parts are biased apart, the female part bears against a curved portion on an outer region of the tines and the male part bears against adjacent flat sides normal to each other on an inner region of the tines.

The present invention extends to a hose coupling including:
a male part having an external annular groove;
a female part having two bores positioned to align with the groove on the male part when the male part is engaged with the female part; and
a staple as in any one of the embodiments described above, the two tines of the staple being inserted into the two bores on the female part to seat within the groove on the male part when the male part and female part are engaged.

For a better understanding of the invention and to show how it may be performed, embodiments of the present invention will now be described, by way of example only, with reference to the accompanying drawings. It is to be understood that the particularity of the drawings does not supersede the generality of the preceding description of the invention.

### BRIEF DESCRIPTION OF THE DRAWINGS

FIG. 1 is an axial cross section of a prior art staple interlocking a male plug and female nut, the staple having D shape cross sectional shaped tines (the D shape cross sectional shaped tine is omitted from one portion, the lower, for clarity);

FIG. 2 is an expanded view of the position circled in FIG. 1;

FIG. 3 is a cross sectional view of a tine of a staple according to an embodiment of the invention;

FIG. 4 is an exploded view of a staple according to an embodiment of the invention and a male plug and female nut.

FIG. 5 is an axial cross section of a staple according to an embodiment of the invention interlocking a male plug and female nut, the staple having irregular cross sectional shaped tines;

FIG. 6 is an expanded view of the position circled in FIG. 5;

FIG. 7 is an isometric view of a staple interlocking a male plug and female nut, the staple having a bent portion.

FIG. 8 is a transverse cross sectional view of a staple with parallel tines interlocking a hose coupling;

FIG. 9 is a transverse cross sectional view of a staple with partly inclined together tines interlocking a hose coupling;

### DETAILED DESCRIPTION OF THE INVENTION

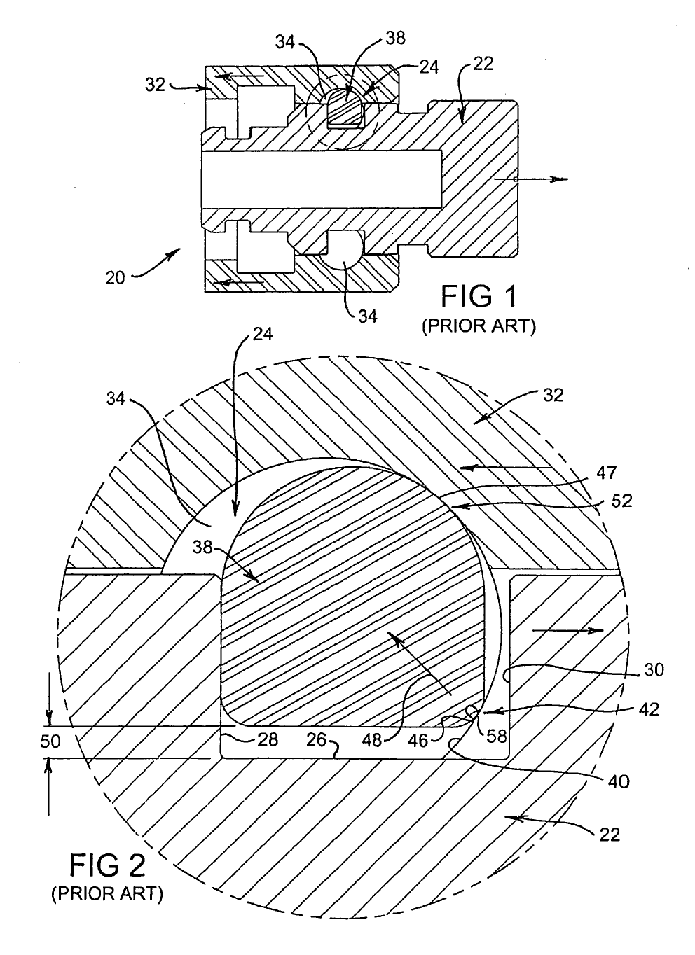

FIGS. 1, 2, 4, 5, 6 and 7 show a male plug and female nut, however, this depiction is for illustrative purposes only and it will be appreciated that the male plug and female nut could be replaced with the male part and female part of a hose coupling. For ease of understanding, the following description refers to the male plug and female nut as the male part and female part of a hose coupling and it is assumed that hoses and/or adapters are connected to the hose coupling.

FIGS. 1 and 2 show a prior art staple with D shape cross sectional shaped tines. The staple is shown interlocking a hose coupling which is under pressure, with arrows showing the direction of the forces acting on the staple and hose coupling.

Referring to FIGS. 1 and 2, the hose coupling 20 includes a substantially cylindrical male part 22, which has an external annular groove 24 that has a base 26 and two flat sides 28 and 30 that are normal to the base 26, and a substantially cylindrical female part 32 which has two bores 34 having a circular cross section, the bores 34 positioned to align with the groove 24 when the male part 22 and female part 32 are engaged. A generally U shaped staple having tines 38 is inserted into the two bores 34 and seated within the groove 24. The tines 38 enter and exit the bores 34 via entry portion and exit portion 40. Entry portion and exit portion 40 extend from the exterior of the female part 32 to the interior of the female part 32.

The pressure in the hose coupling 20 causes the male part 22 and female part 32 to bias apart. As represented in FIGS. 1 and 2 the male part 22 is biased to the right and the female part 32 is biased to the left.

Referring to FIG. 2, as the male part 22 and female part 32 are biased apart, the female part 32 bears against the corner 42 of the D shape cross sectional shaped tine 38 at positions 46 on the tine 38 where the tine 38 is seated in entry portion and exit portion 40. The extent of the positions 46 on the tine 38 that the female part 32 bears against depends on the angle of the tine 38 relative to the bore 34. A resultant force 48 biases the tine 38 in a direction that is outwardly of the groove 24 of the male part 22, leaving a clearance 50 between the tine 38 and the base 26 of the groove 24. Therefore the load bearing area 53 on the flat side 28 of the male part 22 is reduced when the male part 22 and female part 32 are biased apart.

The female part 32 also bears against curved portion 52 of the D shape cross sectional shaped tine 38 at positions 47 on the tine 38 where the tine 38 is seated within the female part 32. The force on the tine 38 at positions 47 is spread over curved portion 52 of the D shape cross sectional shaped tine 38. However, the force on the tine 38 at positions 46 is focussed on corner 42 of the D shape cross sectional shaped tine 38, causing wear and localised stress to the tine 38 at positions 46 and wear and localised stress to positions 58 on the female part 32 that bear against the tine 38 at positions 46.

Similar disadvantages occur when staples with other known symmetrical tine cross sectional shapes, such as square/rectangular and circular are used to interlock the hose coupling 20. Generally, the resultant force developed on tines with these cross sectional shapes by the female part 32 when the hose coupling 20 is under pressure biases the tines in a direction that is outwardly of the groove 24 on the male part 22, leaving a clearance between the tine and the base 26 of the groove 24. Also, the male and female parts 22 and 32 bear against particular positions on these tine cross sectional shapes, causing wear and localised stress to the tine at these positions and to the corresponding positions on the male and female parts 22 and 32 that bear on the tines.

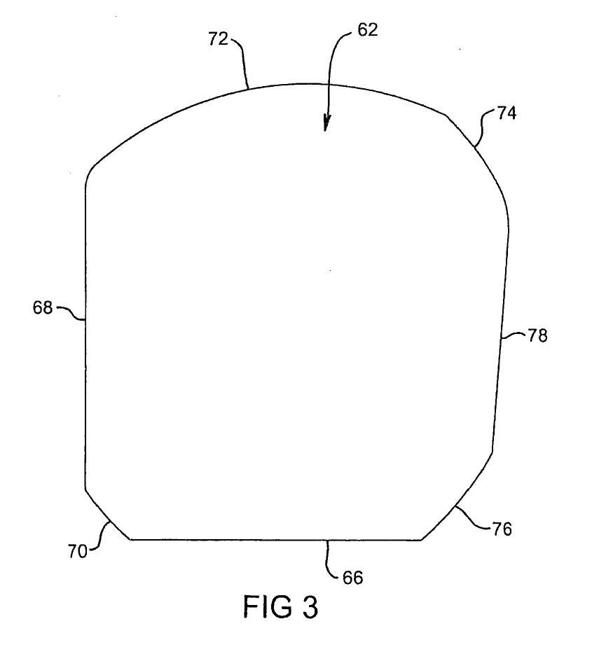

FIG. 3 shows an irregular cross sectional shaped tine 62 of a generally U shaped staple 64 in accordance with an embodiment of the invention. The irregular cross sectional shaped tine 62 has adjacent flat sides 66 and 68 normal to each other that bear against the groove 24 of the male part 22 when the male and female parts 22 and 32 are biased apart, a shaped portion 70, which could be curved or chamfered, between the adjacent flat sides 66 and 68 that facilitates the seating of the tine 62 in the groove 24 on the male part 22, a curved side 72 on an outer region of the tine 62, a curved portion 74 on the outer region of the tine 62 that the female part 32 bears against when the male and female parts 22 and 32 are biased apart, a clearance portion 76 on an inner region of the tine 62 that provides a clearance between the female part 32 and the inner region of the tine 62 when the male and female parts 22 and 32 are biased apart and a flat side 78 connecting the curved portion 74 and the clearance portion 76.

In one embodiment, the radius of the curved portion 74 is about 5 mm, the radius of the clearance portion 76 is about 3.5 mm, the radius of the shaped portion 70 is about 3 mm and the radius of the curved side 72 is about 5.5 mm.

As defined hereinbefore, the “outer region” of the tine 62 is a region of the tine 62 that is positioned outwardly of the U of the staple 64 and in use, sits outwardly of the groove 24 on the male part 22. An “inner region” of the tine 62 is a region on the tine 62 that is positioned inwardly of the U of the staple 64 and in use sits within groove 24 of the male part 22. In FIG. 3, the curved side 72 and curved portion 74 are on an “outer region” of tine 62 and the shaped portion 70 and clearance portion 76 are on an “inner region” of tine 62.

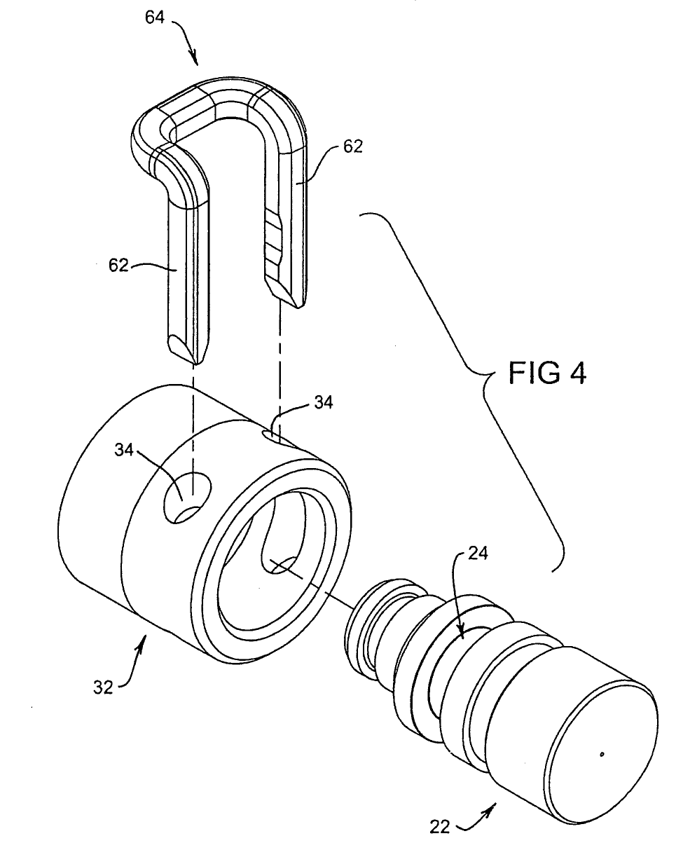

In FIG. 4, the staple 64 is shown with the male part 22 and female part 32 in an exploded view. The staple 64 has two irregular cross sectional shaped tines 62 that are insertable into the two bores 34 of the female part 32 to seat within the annular groove 24 of the male part 22 when the male part 22 and female part 32 are engaged. It also has chamfered ends 65 for ease of insertion and removal of the staple 64 from the hose coupling 20. The chamfer may be on the side of the tine facing the female part or the side of the tine facing the male part or on both sides of the tine, as shown in FIG. 4.

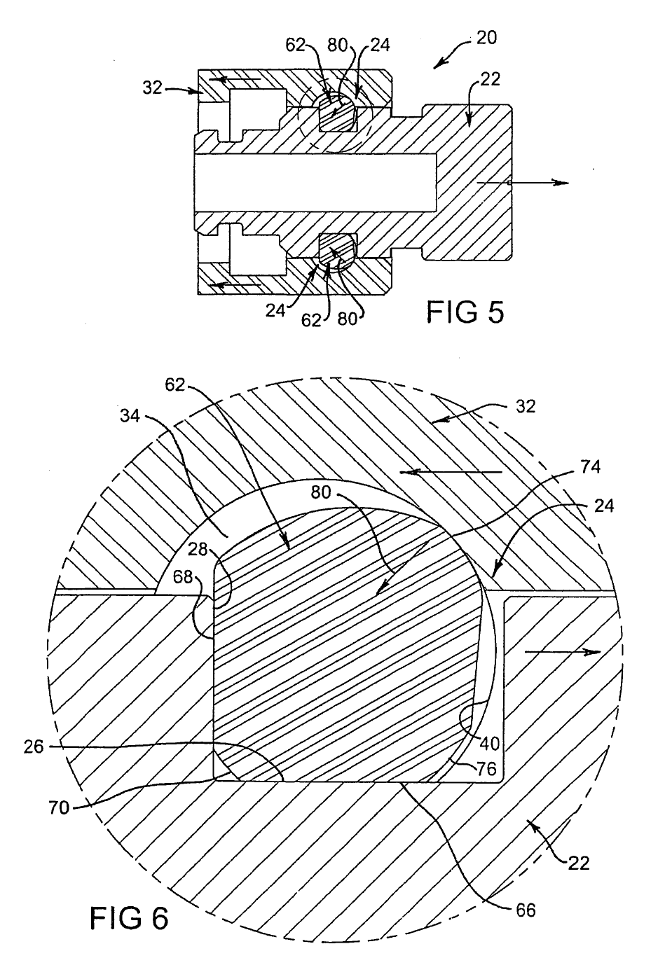

FIGS. 5 and 6 show the staple 64 interlocking a hose coupling that is under pressure, with the male part 22 being biased to the right and the female part 32 biased to the left as shown by arrows. The female part 32 bears against an outer region of the tines 62 at curved portion 74 of the irregular cross sectional shaped tines 62 to provide a resultant force 80 which biases the tines into the groove 24. The flat sides 66 and 68 contact and exert a force on the base 26 and an adjacent side 28 of the groove 24. The female part 32 does not bear against an inner region of the tines 62 at positions where the tines 62 are seated in entry portion and exit portion 40 as the clearance portion 76 of the irregular cross sectional shaped tines 62 provides a clearance between the tines 62 and the female part 32.

Unlike known staples, the staple of the present invention has the advantage that when the male part 22 and female part 32 are biased apart when the hose coupling 20 is under pressure, the resultant force 80 on the tines 62 of the staple 64 biases the tines 62 into the groove 24. This means that it is less likely that the staple 64 will be unintentionally removed from the hose coupling 20 whilst it is under pressure.

The biasing of the tines 62 into the groove 24 on the male part 22 is allowed by the irregular cross sectional shape of the tines 62, such that when the male part 22 and female part 32 are biased apart, the female part 32 bears against an outer region of the tines 62 and there is a clearance between the female part 32 and an inner region of the tines 62. The present invention extends to all embodiments of a staple with tines that have such an irregular cross sectional shape.

Unlike known staples, the staple of the present invention has the further advantage that when the male part 22 and female part 32 are biased apart, the tines 62 contact and exert a force on the base 26 of the groove 24 rather than riding up to leave a clearance between the tine 62 and the base 26 of the groove 24. This increases the load bearing area 59 on the flat side 28 of the male part 22 when the male part 22 and female part 32 are biased apart. In addition, the load is spread across both the base 26 and flat side 28 of the groove 24.

Referring again to FIGS. 1 and 2, it can be seen that the corner 42 of the D shape cross sectional shaped tine 38 is at an inner region of the tines 38. The curved portion 52 of the D shape cross sectional shaped tine 38 is at an outer region of the tines 38. The female part 32 thus bears on the tines 38 at an inner region of the tines 38 when the hose coupling 20 is under pressure, causing a resultant force 48 on the tines 38, biasing them out of the groove 24. In addition, the resultant force 48 on the tines 38 causes the tines 38 ride up in the groove 24 to create a clearance 50 between the tine 38 and the base 26 of the groove 24.

The same effect can be observed in known square/rectangular and circular cross sectional shaped tines.

The irregular cross sectional shape of the tines 62 may be varied to suit different cross sectional shapes of groove 24 on the male part 22 and bores 34 in the female part 32. For example, if the bore 34 in the female part 32 had a square cross sectional shape, the irregular cross sectional shape of the tines 62 may have a square corner that the female part 32 bears against when the hose coupling 20 is under pressure. What is important is that the female part 32 bears against an outer region, but not an inner region, of the tines 62.

Another advantage of the embodiment of the present invention shown in FIGS. 5 and 6 is that the irregular cross sectional shape of the tines 62 provides a large area of contact between the tines 62 and the male and female parts 22 and 32 when biased apart, compared to known staples. The curved portion 74 substantially matches the curve of the bores 34 of the female part 32 and the flat sides 66 and 68 match the base 26 and adjacent flat side 28. The male part 22 and female part 32 thus bear on a greater area of the irregular cross sectional shaped tines 62 when the hose coupling 20 is under pressure, causing less wear and localised stress to the tines 62 and male and female parts 22 and 32.

The irregular cross sectional shaped tines 62 also have a larger cross sectional area than the cross sectional area of known symmetrical square/rectangular, circular and D shape cross sectional shaped tines for use in the same sized hose coupling. The cross sectional area of the irregular cross sectional shaped tines 62 may be up to about 30% greater than the cross sectional area of prior art square cross sectional shaped tines. The larger cross sectional area means that the staple has greater strength and a longer useful life.

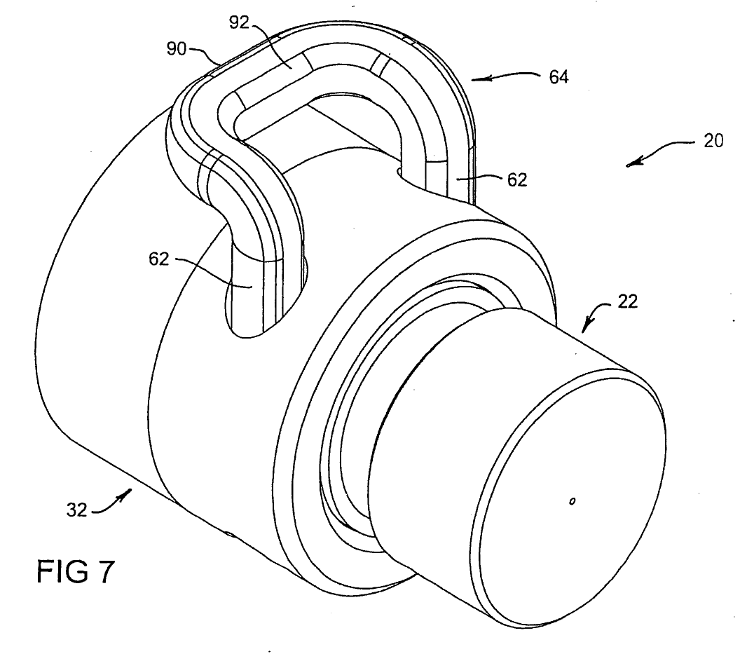

In order to determine the orientation in which a staple should be inserted, the staple 64 as shown in FIG. 7 has a bent portion 90 that lies on an angle of substantially 90 degrees to the tines 62. The bent portion 90 provides a useful visual and tactile indicator of the orientation in which the staple 64 should be inserted into the hose coupling 20. It is useful for both symmetrical cross section staples (which should be reinserted in the same orientation once removed) and non-symmetrical cross section staples.

The bent portion 90 also provides an area 92 of the staple which may be labelled. The area 92 provides a particularly advantageous position to place a label as it is an easily visible, low stress area of the staple 64 that does not affect the functionality of the staple 64.

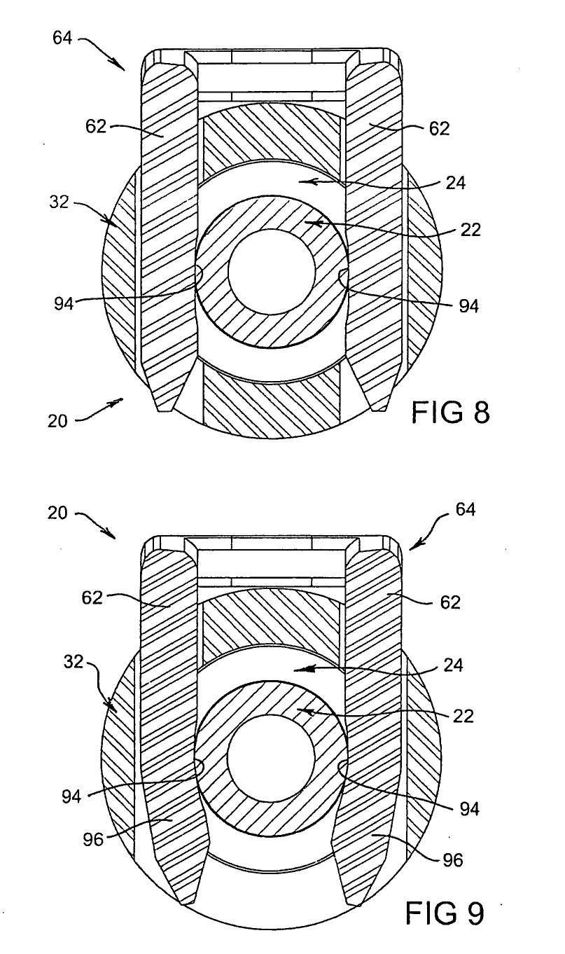

In FIG. 8, the tines 62 of the staple 64 have recesses 94 that are seated within the groove 24. The recesses 94 are substantially the length of the groove 24. The recesses 94 allow the tines 62 to grip around the groove 24, further tightening the interlock between the male part 22 and female part 32, making it even less likely that the staple 64 will be unintentionally removed from the hose coupling 20 when it is under pressure. The recesses 94 in combination with the biasing of the tines 62 into the groove 24 prevent the tines 62 from bending when the hose coupling 20 is under pressure.

The tines 62 in FIG. 8 are parallel to each other, providing the advantage that the tines 62 are not biased away from the groove 24 and are therefore not as likely to be unintentionally removed from the hose coupling 20 whilst it is under pressure. When the hose coupling 20 is not under pressure, the recesses 94 hold the tines 62 in the hose coupling 20.

The staple 64 in FIG. 9 has tines 62 that are partly parallel and partly inclined together. The inclined part 96 of the tines 62 provides an additional grip between the staple 64 and the hose coupling 20, which resists the removal of the staple 64 from the hose coupling 20.

The staple 64 may be made from spring steel and could be formed by extrusion and shaping.

It is to be understood that various alterations, additions and/or modifications may be made to the parts previously described without departing from the ambit of the present invention, and that, in the light of the above teachings, the present invention may be implemented in a variety of manners as would be understood by the skilled person.

1. A staple for interlocking an engageable male part and a female part of a hose coupling, the male part having a longitudinal axis and an external annular groove and the female part having two bores positioned to align with the groove on the male part when the male part is engaged with the female part, the staple having two tines which are insertable into the two bores on the female part to seat within the groove on the male part when the male part and female part are engaged, wherein the tines each have an irregular cross sectional shape such that when the male and female parts are biased apart, the female part bears against an outer region of the tines such that there is a resultant force which biases the tines into the groove.

2. A staple as claimed in claim 1, wherein the groove on the male part has a base surface and the cross section of the tines is such that when the male and female parts are biased apart, the female part bears against the tines such that the tines contact and exert a force on the base surface of the groove.

3. A staple as claimed in claim 1, wherein the cross section of the tines has an clearance portion on an inner region of the tines such that when the male and female parts are biased apart there is a clearance between the female part and an inner region of the tines.

4. A staple as claimed in claim 1, wherein the cross section of the tines has a curved portion on an outer region of the tines that the female part bears against when the male and female parts are biased apart.

5. A staple as claimed in claim 1, wherein the cross section of the tines is non-symmetrical.

6. A staple as claimed in claim 1, wherein the cross section of the tines has adjacent flat sides normal to each other that bear against a side and base surface of the groove on the male part when the male and female parts are biased apart.

7. A staple as claimed in claim 1, wherein the cross section of the tines has a shaped portion on an inner region of the tines opposite the outer region of the tines that the female part bears against, for facilitating the seating of the tines within the groove.

8. A staple as claimed in claim 1, wherein the cross section of the tines has adjacent flat sides normal to each other, a shaped portion between the adjacent flat sides, a curved side on an outer region of the tines including a curved portion that the female part bears against when the male and female parts are biased apart, a clearance portion on an inner region of the tines that provides a clearance between the female part and the inner region of the tines when the male and female parts are biased apart and a flat side connecting the curved portion and clearance portion.

9. A staple as claimed in claim 1, wherein at least one of the tines has a recess that seats within the groove on the male part when the male and female parts are engaged and the staple is fully inserted.

10. A staple as claimed in claim 9, wherein the recess has a length that is substantially the diameter of the groove.

11. A staple as claimed in claim 1, wherein the tines are parallel to each other.

12. A staple as claimed in claim 1, wherein the tines are inclined together.

13. A staple as claimed in claim 1, wherein the tines are partly parallel and partly inclined together.

14. A staple as claimed in claim 1, wherein the staple has a bent portion connecting the two tines, the bent portion lying on an angle to the tines.

15. A staple as claimed in claim 14, wherein the bent portion lies on an angle of substantially 90 degrees to the tines.

16. A staple as claimed in claim 1, wherein the staple tines have chamfered ends.

17. A staple for interlocking an engageable male part and a female part of a hose coupling, the male part having a longitudinal axis and an external annular groove and the female part having two bores positioned to align with the groove on the male part when the male part is engaged with the female part, the staple having two tines which are insertable into the two bores on the female part to seat within the groove on the male part when the male part and female part are engaged, wherein the tines each have an irregular cross sectional shape such that when the male and female parts are biased apart, the female part bears against a curved portion on an outer region of the tines and the male part bears against adjacent flat sides normal to each other on an inner region of the tines.

18. A hose coupling including:
a male part having an external annular groove;
a female part having two bores positioned to align with the groove on the male part when the male part is engaged with the female part; and
a staple as claimed in claim 1, the two tines of the staple being inserted into the two bores on the female part to seat within the groove on the male part when the male part and female part are engaged.
